(19) United States
(12) Patent Application Publication
(10) Pub. No.: US 2005/0268671 A1
(43) Pub. Date: Dec. 8, 2005

(54) Process of tanning hide

(76) Inventor: Wagner C. F. Lourenco, Cidade Universitaria (BZ)

Correspondence Address: BROOKS KUSHMAN P.C., 1000 TOWN CENTER, TWENTY-SECOND FLOOR, SOUTHFIELD, MI, 48075, US

(21) Appl. No.: 10/523,773

(22) PCT Filed: Aug. 8, 2003
(86) PCT No.: PCT/BR03/00110

§ 371 Date: Feb. 8, 2005

(30) Foreign Application Priority Data
Aug. 9, 2002 (BR) PI-0203260-0

(51) Int. Cl. C14B 1/00

(52) U.S. Cl. 69/21

(57) ABSTRACT

The present invention relates to a process of tanning where the step of contacting the hides with chromium salts is preceded by acidification with organic acids sufficient to reach a pH of from about 3.5 to 5 at the surface of the hide and pH of from about 4.0 to 6.5 at the internal part of a cross section of the hide.

### FIELD OF THE INVENTION

The present invention is related to a process of tanning hide to obtain leather. More specifically, it refers to an improvement introduced in the conventional process of tanning hide with chrome to obtain equal or better quality leather, despite eliminating steps considered as essential until the moment.

### STATE OF THE ART

Hide tanning is a process in which the collagen protein present therein reacts with tanning agents, originating leather—the tanning process is therefore one of the essential steps in leather production process. It is a very old process, whose purpose is to avoid hide degradation and putrefaction, by means of a protein crosslinking phenomenon caused by the action of the employed tanning agent.

For chrome tanning producing “Wet Blue” (an intermediary stage prior to obtaining the final leather), traditionally used tanning agents are chrome III salts, such as chrome sulfate or basic chrome sulfate. Typically, a leather has already been tanned when the hide incorporates about 3.5% by weight of chrome oxide, Cr₂O₃, dry basis, thus obtaining retraction test resistant leathers.

In the traditional processes of tanning hide, only 70% to 80% of chrome oxide available in the tanning bath is used. This means that the use of a large excess of salt is required, imposing additional costs to the process and generating an undesirable residue, potentially causing damaging impact to the environment and requiring storage and/or chemical treatment before disposal. Despite the fact that chrome III compounds are not damaging to plants and animals, especially under neutral conditions, international rules impose low limits to the presence of chrome III and other heavy metals in water and air.

It is known that this problem has been object of study and solution attempts have been searched. American patents U.S. Pat. No. 4,715,861 and U.S. Pat. No. 4,978,361 describe better hide absorption of chrome by hide by means of supplementary addition of chemical compounds. American patent U.S. Pat. No. 4,042,321 proposes recycling the tanning bath by a complex and costly process aiming the reduction of effluents treatment, being, however, complicated due to the accumulation of salts and fiber residues. European patents EP 822,263 and Brazilian patents BR 9603419-0 and BR 9702025-7 disclose larger exhaustion of the chrome bath by the use of aldehyde, which is very toxic. As a rule, the state of the art always proposes more steps and/or the use of more raw materials to deal with the problem.

It is additionally verified that proposed solutions generally assume that hide tanning is achieved according to a little elucidated process, according to which (1) chrome salt is firstly introduced in the hide under pH between 2.5 and 3, in the presence of sodium chloride in the tanning bath, when the affinity of chrome salts and terminal carboxylic groups of collagen (protein) is minimum, avoiding the precipitation and staining of the hide (stage known as pickling); (2) followed by fixing chrome to the hide, raising pH to between 3.8 and 4.2, causing the reaction between the terminal carboxylic groups of the protein and chrome salts (stage known as basification). In this conventional process, the low pH of the bath (2.5 to 3), considered an essential requirement, is usually reached by the addition of organic acids until pH between 4 and 6, followed by the addition of strong acids such as sulfuric or hydrochloric acid until pH between 2.5 and 3.

The basification step, as currently used, requires careful controls, since the speed or excessive amount in the addition of the basifying agent may cause stains in the leather, being therefore a step to be performed with care and attention.

Surprisingly and contrary to any disclosure in the state of the art, the Applicant found that enough chrome can be fixed to the hide in a tanning process, similar to the traditional one, but using less acid pH range than that used until the moment. Some advantages of this innovation are the following:
the use of strong acids, such as sulfuric or hydrochloric acid, is fully excluded from the tanning process, making it safer from the operators' health point of view;
the chrome salt in the tanning bath is more efficiently used, and the quantity of offered chrome salt can be reduced with relation to the excess needed in the traditional process, reducing its costs;
the use of lower quantities of salt, sodium chloride, or even its full exclusion is possible;
less potentially harmful to nature residues are generated; the generation of less polluting residues requires less treatment than needed in traditional process;
the basification step is excluded, whose purpose was to raise the pH of the tanning bath to fix the chrome to the protein;
it allows the tanning bath to be recycled;
the total time to process the hide to obtain leather is reduced.

### DETAILED DESCRIPTION OF THE INVENTION

The invention refers to a process of tanning hide that, after being delimed and purged, and before the addition of chrome salt, are submitted to acid conditioning, particularly using organic acids, until the pH of the hide surface is between about 3.5 and 5, more particularly between 3.8 and 4.2, and the pH of the internal part of a cross section of the hide is between about 4.0 and 6.5, more particularly between 4.5 and 5.5. Consequently, the pH of the bath should be within the range of about 3.5 to 5, particularly between 4 to 5.

The pH of a cross section of the hide and the external pH of the hide are checked, particularly with the use of a universal indicator conventionally prepared as widely described in the technical literature, while the pH of the bath is checked by any known means, such as a pH meter.

The hide preparation step as mentioned above before acidifying is known by the person skilled in the art, and can include one or more of the following operations, some of which can be simultaneously performed: conservation of the hide by adding salt, aiming the transport of the hide from the slaughter house to the tannage; new bath step; epilation; liming; deliming and purge.

Leathers obtained by the process of the invention present chrome oxide fixing higher than about 3.7% (dry basis), enough to resist the refraction test (boiling test), transforming the hide in tanned leather. They also present 100% of traversing chrome in a cross section of the hide, checked as known and usual in the tanning field, by means of visual observation.

Since in the process of the present invention hide conditioning before incorporating chrome is made at a higher pH than practiced in the traditional processes, the use of a strong acid, such as hydrochloric or sulfuric acid, in the pickling stage, and the use of basifying agents, such as magnesium oxide, are excluded; there are, therefore, additional benefits, since operators of that industry are then less exposed to the aggressive environment of strong acids and less polluting charge is released to the environment.

The process of the invention can also comprise intermediary operations such as washings, bath exhaustions, pH settings, etc., and subsequent operations, such as neutralization, washings, dryings, re-tanning, dying, etc. These are operations known by the one skilled in the art that are not essential aspects of the invention.

In a particular embodiment, the chrome tanning in the process of the invention is made with basic chrome sulfate Cr(OH)SO₄, about 33% basic in Schrolemmer grades and about 25% to 26% in chrome III oxide or any other commercial product based on chrome, liquid or powder, at variable concentrations as traditionally used and is of public domain in the art of leather tanning. Still particularly, between 5% and 7% by weight of chrome salt relative to the weight of the hide is used for a period between e.g. 1 and 6 hours.

Organic acids appropriate to the acidifying step in the process of the invention are any acids, particularly those chosen from formic, acetic, dicarboxylic acids such as succinic, glutaric or adipic acid, anhydrides such as maleic or fumaric anhydrides, tricarboxylic and hydroxycarboxylic acids and their mixtures. More specifically, acids are chosen from acetic, formic, succinic, glutaric, adipic acids, maleic and fumaric anhydrides, and their mixtures. Acidification to the pH ranges as established above typically takes between 1 and 5 hours.

The time duration for each process step of the invention will depend on the thickness of the hide to be tanned, generally defined as “divided hide”, presenting about 3 to 4 mm thickness that is less thick and will take less time to be tanned than the integral hide that is thick (e.g. 7 to 12 mm), or even than “laminated integral” hide (about 7 to 8 mm). One skilled in the art knows how to determine the time to perform said steps.

The quantity of acid used for conditioning is typically between 0.3% and 1.1% by weight relative to the weight of the hide, depending on the concentration of the acid solution and its composition.

In the final step, the process of the invention uses the addition of a salt, such as sodium formate, sodium acetate or another salt known by the person skilled in the art, to regulate the final pH and provide higher exhaustion of chrome in the tanning bath. About 0.4% to about 1.2% by weight relative to the weight of the hide is added, depending on the thickness of the leather to be tanned, particularly about 0.4% to about 0.8% and, even more particularly, about 0.4% to about 0.5% for divided leathers and particularly between about 0.6% to about 1.0% for integral leathers, with the beater drum turning for about 3 to 16 hours, particularly between 3 and 8 hours, more particularly between 3 and 5 hours.

The process is performed at room temperature, but the temperature is increased by the hide charge itself and by the mechanical effect caused by the beater drum, besides the tanning reactions, and can reach about 40° C. Additional heating, whose purpose is to better exhaust the chrome bath, can be applied at the end of the process, while the bath reaches temperatures of about 40 to 50° C.

The quality of the tanned leather obtained by the process of the invention is typically higher than for the leathers obtained by the prior art processes, bearing in mind that the quality of “Wet Blue” is higher regarding the quality of flower and filling of empty portions. Furthermore, yielding is higher, since the area of tanned leather is better used, as the tanning process is less aggressive and does not require different pH levels.

In the “Wet Blue” quality, the leather obtained by means of the process of the invention presents, in a histological cut, better fiber packing in the flower in comparison to traditional processes, under lower pH.

The examples below present some embodiments of the invention. Said examples only illustrate possible embodiments of the invention, not imposing any qualitative or quantitative limitation other than the ones indicated in the attached claims.

### EXAMPLE 1

Divided hide with 3 to 4 mm thickness (5000 kg) is delimed and purged as traditionally done, with the use of ammonium sulfate, ammonium chloride, a commercial deliming agent (e.g. Rhodiaeco Descal LQ, commercialized by Rhodia Poliamida e Especialidades) and a commercial proteolytic enzyme. At the end of these operations, the cross section of the hide is colorless to phenolphthalein. With relation to the hide weight, 60% water, 6 to 7% sodium chloride (Bé=5.5 to 7), 0.4 to 0.5% commercial bleaching and 0.2% anionic surfactant are added and turned for about 15 minutes. 0.5% formic acid solution at 85% is added. The beater drum is turned for 2.5 hours. After this period, pH of the bath is about 4.5 and the cross section of the hide has external pH of about 3.8 and internal pH of about 4.8.6% basic chrome sulfate, which presents 33% alkalinity and 25 to 26% chrome III oxide, is added and turned for 3.5 hours. At the end of this period, chrome presents crossing higher than 80%. About 0.4% sodium formate is added and turned for about 7 hours. The final temperature of the bath is about −42° C. and final pH is about 3.80. After the usual finishing process, obtained leathers are smooth, presenting plain and fine flower and uniform dye.

### EXAMPLE 2

Divided hide with 3 to 4 mm thickness (5000 kg) is delimed and purged as traditionally done, e.g. with the use of ammonium sulfate, ammonium chloride, a commercial deliming agent (e.g.: Rhodiaeco Descal SD, commercialized by Rhodia Poliamida e Especialidades) and a commercial proteolytic enzyme. At the end of these operations, the cross section of the hide is colorless to phenolphthalein. With relation to hide weight, 30 to 40% water, 5 to 6% sodium chloride (Bé=5.5 to 7), 0.4 to 0.5% commercial bleaching and 0.2% anionic surfactant are added and turned for about 10 minutes. 0.4% commercial acid solution are added, e.g. Rhodiaeco Formiplus sold by the company Rhodia Poliamida e Especialidades. The beater drum is turned for about 2 hours. After this period, pH of the bath is about 5 and the cross section of the hide has external pH of about 3.5 and internal pH of about 5.5. 5.5% basic chrome sulfate, which presents 33% alkalinity and 25 to 26% chrome III oxide, is added and turned for about 3 hours. At the end of this period, chrome presents crossing higher than 90%. About 0.5% sodium formate is added and turned for about 4 hours. The final temperature of the bath is about 40° C. and the final pH is about 4.0. Chrome fixed is in the 4% range with very low chrome residual in the bath. After the usual finishing process, obtained leathers are smooth, presenting plain and fine flower and uniform dye.

### EXAMPLE 3

Divided hide with 3 to 4 mm thickness (8000 kg) is delimed and purged as described in examples 1 and 2, about 35% water, about 5% sodium chloride (Bé=5.5 to 7), about 0.4% commercial bleaching and 0.2% anionic surfactant are added and turned for about 15 minutes. About 0.5% acid solution containing equal quantities of acetic, glutaric, adipic and succinic acids is added. The beater drum is turned for about 2 hours. At the end of this period, pH of the bath is about 4.5 and the cross section of the hide has external pH of about 3.8 and internal pH of about 4.7. About 5.3% basic chrome sulfate, which presents 33% alkalinity and 25 to 26% chrome III oxide, is added and turned for about 3.5 hours. At the end of this period, chrome presents crossing higher than 90%. About 0.5% sodium formate is added and the beater drum is turned for about 7 hours. The final temperature of the bath is about 40° C., pH is about 4 and the residual bath contains about 0.026% chrome.

### EXAMPLE 4

Divided hide with 3 to 4 mm thickness (5000 kg) is submitted to deliming and purge operations as described in examples 1 and 2. With relation to hide weight, about 40% water, about 5.5% sodium chloride (Bé=5.5 to 7), about 0.5% commercial bleaching and 0.2% anionic surfactant are added and turned for about 15 minutes. About 0.4% commercial acid solution (e.g. Rhodiaeco Formiplus commercialized by Rhodia Poliamida e Especialidades) is added. The beater drum is turned for about 1.5 hours. After this period, pH of the bath is about 4.2 and the cross section of the hide has external pH of about 3.8 and internal pH of about 5.5. About 5% basic chrome sulfate, which presents 33% alkalinity and 25 to 26% chrome III oxide, is added and turned for about 3 hours. At the end of this period, chrome presents crossing of nearly 100% in the cross section of the hide. About 0.5% sodium formate is added and the beater drum is turned for about 3 hours. The final temperature of the bath is near 42° C. and the final pH is about 3.9. The fixed chrome is about 4.2% and the residual bath contains about 0.04% chrome.

### EXAMPLE 5

Laminated integral hide which is 7.0 to 7.5 mm thick (5000 kg) is submitted to deliming and purge operations as described in examples 1 and 2. With relation to hide weight, about 55% water, about 6.5% sodium chloride (Be =5.5 to 7), about 0.45% commercial bleaching and about 0.3% anionic surfactant are added and the beater drum is turned for about 15 minutes. About 0.8% formic acid solution at 85% is added. The beater drum is turned for about 5 hours. At the end of this period, pH of the bath is about 5 and the cross section of the hide has external pH of about 4 and internal pH of about 5. About 6% basic chrome sulfate, which presents 33% alkalinity and 25 to 26% chrome III oxide, is added and turned for about 5 hours. At the end of this period, chrome presents crossing higher than 80%. About 1% sodium formate is added and turned for about 15 hours. The final temperature of the bath is about 42° C. and final pH is about 4. After the usual finishing process, obtained leathers are smooth, presenting plain and fine flower and uniform dye.

### EXAMPLE 6

Laminated integral hide which are 7.0 to 7.5 mm thick (8000 kg) are submitted to deliming and purge operations as described by Ex. 1 and 2. With relation to hide weight, about 30% water, about 5.5% sodium chloride (Be =5.5 to 7), about 0.35% commercial bleaching and about 0.3% anionic surfactant are added and turned for 10 to 15 minutes. 0.8% to 1% commercial acid is added, e.g. Rhodiaeco Formiplus commercialized by Rhodia Poliamida e Especialidades. The beater drum is turned for about hours. At the end of this period, pH of the bath is about 5 and the cross section of the hide has external pH of about 4 and internal pH of about 5. About 5.2% basic chrome sulfate, which presents 33% alkalinity and 25 to 26% chrome III oxide, is added and turned for about 5 hours. At the end of this period, chrome presents crossing of nearly 100%. About 0.8% sodium formate is added and the beater drum is turned for about 15 hours. The final temperature of the bath is about 40° C. and the final pH is about 4.0.

### EXAMPLE 7

Integral hide (8000 kg) is submitted to deliming and purge operations as described in examples. 1 and 2. With relation to hide weight, about 30% water, about 5% sodium chloride (Bé=5.5 to 7), about 0.3% commercial bleaching and about 0.4% anionic surfactant are added and the beater drum is turned for about 15 minutes. About 1.1% acid solution containing a mixture of acetic and other organic dicarboxylic acids is added. The beater drum is turned for about 4 hours. At the end of this period, pH of the bath is about 4.5 and the cross section of the hide has external pH of about 4.2 and internal pH of about 5.5. About 5.5% basic chrome sulfate, which presents 33% alkalinity and 25 to 26% chrome III oxide, is added and turned for about 6 hours. At the end of this period, chrome presents full crossing in the cross section of the hide. About 0.9% sodium formate is added and turned for about hours. The final temperature of the bath is about 40° C. and the final pH is about 4.0. At the end, the fixed chrome is about 4% expressed as Cr₂O₃, dry basis.

### EXAMPLE 8

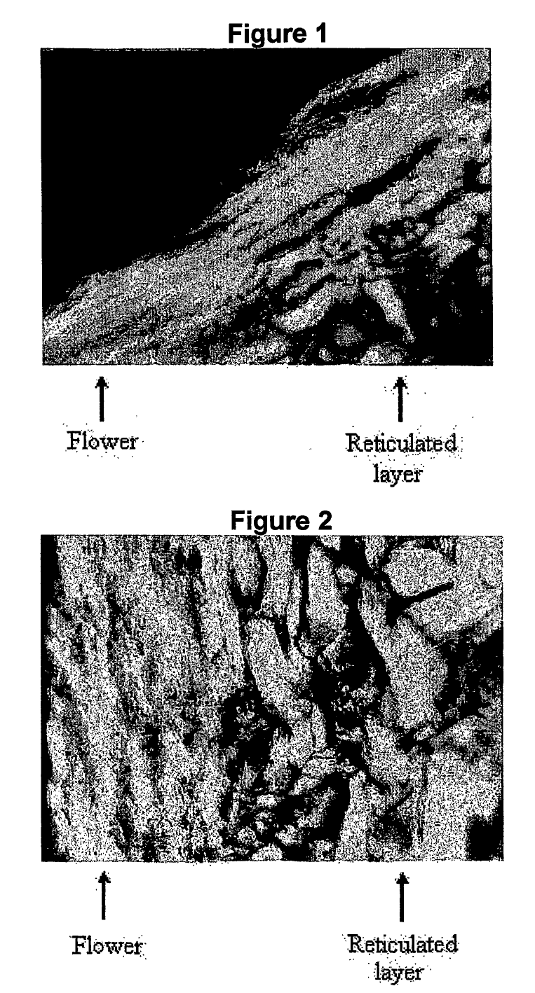

Two samples of Wet Blue leathers, one produced by the process of the present invention (A) in Example 1 and another by conventional process (B) (similar to Example 1 but comprising an additional acidification step with sulfuric acid, enough to lower the bath pH to 2.5 before the chrome bath, and a later basification step with magnesium oxide until pH 4.0), present significant differences in the flower layer, as shown by the attached FIGS. 1 and 2. These are photographs taken by polarized light optical microscopy for Wet Blue leather samples produced by the process of the invention on FIG. 1 and by the traditional process on FIG. 2, by using a Vibratome microtome to prepare the cross section of the hide and Nikon Optipht photomicroscope for polarized light optical microscopy photos.

One can see that, in the flower layer of the Wet Blue leather obtained by the process of the present invention (FIG. 1), fiber packing is higher in comparison with the flower layer of the Wet Blue leather obtained by the conventional process (FIG. 2).

1. A process of tanning hide comprising, before submitting the hide to contact with chrome salts, an acidification step wherein an external pH of the hide reaches values between about 3.5 and 5 and a pH of an internal part of a cross section of the hide is between about 4.0 and 6.5.

2. The process according to claim 1, wherein the acidification is carried out by means of organic acids.

3. The process according to claim 2, wherein the organic acids are selected from formic, acetic, dicarboxylic acids including succinic, glutaric or adipic acid, maleic or fumaric anhydrides, tricarboxylic and hydroxycarboxylic acids and their mixtures.

4. The process according to claim 3, wherein the organic acid is one from acetic, formic, succinic, glutaric or adipic acid, maleic or fumaric anhydrides or their mixtures.

5. The process according to claim 1, wherein the external pH of the hide is about 3.8 to 4.2 and the pH of the internal part of a cross section of the hide is between about 4.0 and 5.5.

6. The process according to claim 1, wherein a pH of an acidification bath reaches values within the range of about 3.5 to 5.

7. The process according to claim 6, wherein the pH of the acidification bath is about 4 to 5.

8. The process according to claim 1, wherein a quantity of added acid is about 0.3 to about 1.1% by weight with relation to a weight of the hide.

9. The process according to claim 1, wherein a duration of the acidification step is enough to reach pH disclosed in any of claims 5 or 6.

10. The process according to claim 9, wherein the acidification step takes about 1 to 5 hours.

11. The process according to claim 1, wherein the chrome salt is basic chrome sulfate in the form of salt and/or in liquid solutions.

12. The process according to claim 11, wherein the chrome salt is a basic chrome sulfate with 33% alkalinity in Schrolemmer grades and about 25 to 26% in chrome III oxide.

13. The process according to claim 1, wherein the chrome salt is present in about 5% to about 7% by weight relative to a weight of the hide.

14. The process according to claim 1, wherein the chrome salt is in contact with the hide for about 1 to 6 hours.

15. The process according to claim 1, wherein a salt is added to regulate the final pH and provide higher exhaustion of chrome in the tanning bath.

16. The process according to claim 15, wherein the salt is sodium formate or acetate.

17. The process according to claim 15, wherein the salt is added in a quantity of about 0.4% to 1.2% by weight, relative to a weight of the hide, depending on the thickness of the hide to be tanned.

18. The process according to claim 17, wherein the salt is added in a quantity of about 0.4% to 0.8% by weight, more particularly about 0.4% to 0.5% for divided hide and about 0.8% to 1.0% for integral hide, relative to the weight of the hide.

19. The process according to claim 15, wherein the salt addition step takes about 3 to 16 hours.

20. The process according to claim 19, wherein the salt addition step takes about 3 to 8 hours, more particularly about 3 to 5 hours.

21. The process according to claim 1, wherein the final bath is heated at temperatures of about 40 to 50° C.

22. A tanned hide that is obtained by means of the process of claim 1.

23. The tanned hide according to claim 22, wherein the hide presents chrome III oxide Cr₂O₃ fixing which is enough to guarantee resistance to a retraction test.

24. The tanned hide according to claim 22, wherein the hide presents chrome III oxide Cr₂O₃ fixing of more than 3.7% (dry basis).

25. The tanned hide according to claim 22, wherein the hide presents chrome crossing higher than 80% in a cross section.

26. The tanned hide according to claim 25, wherein the hide presents 100% chrome crossing in a cross section.

27. The tanned hide according to claim 22, wherein the hide provides denser fiber packing in comparison to hide tanned by a traditional process.
